(19) United States
(12) Patent Application Publication
(10) Pub. No.: US 2010/0182493 A1
(43) Pub. Date: Jul. 22, 2010

(54) ELECTRONIC CAMERA

(75) Inventors: Motohiro Yuba, Osaka (JP); Naoki Yonetani, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/650,043

(22) Filed: Dec. 30, 2009

(30) Foreign Application Priority Data
Jan. 21, 2009 (JP) 2009-010522

(51) Int. Cl. H04N 5/232

(52) U.S. Cl. 348/348; 348/E05.045

(57) ABSTRACT

An electronic camera includes an imaging device. The imaging device repeatedly outputs an object scene image produced on an imaging surface capturing an object scene through a focus lens. A position of the focus lens is repeatedly changed by a moving amount Wrough under the control of a CPU. Moreover, a distance from the focus lens to the imaging surface is repeatedly changed by a moving amount Wfine, smaller than the moving amount Wrough, under the control of the CPU. The CPU adjusts the position of the focus lens to a position corresponding to a focal point, based on the object scene image outputted from the imaging device, in parallel with such a rough adjusting process and/or a fine adjusting process. However, the CPU restricts the rough adjusting process when the contrast of an object belonging to the object scene falls below a reference.

### CROSS REFERENCE OF RELATED APPLICATION

The disclosure of Japanese Patent Application No. 2009-10522, which was filed on Jan. 21, 2009, is incorporated herein by reference.

### BACKGROUND OF THE INVENTION

1. Field of the Invention

The present invention relates to an electronic camera. More specifically, the present invention relates to an electronic camera which adjusts a distance from a focus lens to an imaging surface to a distance corresponding to a focal point.

2. Description of the Related Art

According to one example of this type of camera, a lens is firstly moved by a rough step, and a rough detection for a focal position according to a normal evaluating method is tested. When the rough detection for the focal position is unsuccessful, the lens is moved again by a rough step, and a rough detection for a focal position according to a low contrast-use evaluating method is attempted. When it is still not possible to detect the focal position even when the low contrast-use evaluating method is used, a warning is issued. On the other hand, when the detection for the focal position according to the normal evaluating method or the low contrast-use evaluating method is successful, the lens is moved by a fine step. At last, a final focal position is detected.

However, if a step width of the lens is large as in the rough detecting operation, it is probable that an exposing operation is started before the completion of the movement of the lens. When such overlapping between a lens moving period and an exposing period is generated, the accuracy for the rough detection for the focal position is decreased in particular when the contrast of a subject is low, which in turn decreases the accuracy for detecting the final focal position.

### SUMMARY OF THE INVENTION

An electronic camera according to the present invention, comprises: an imager which repeatedly outputs an object scene image produced on an imaging surface capturing an object scene through a focus lens; a first changer which repeatedly changes by each first amount a distance from the focus lens to the imaging surface; a second changer which repeatedly changes by each second amount, smaller than the first amount, the distance from the focus lens to the imaging surface; an adjuster which adjusts the distance from the focus lens to the imaging surface to a distance corresponding to a focal point based on the object scene image outputted from the imager, in parallel with a changing process of the first changer and/or the second changer; and a restrictor which restricts the changing process of the first changer when a contrast of an object belonging to the object scene falls below a reference.

Preferably, further comprised are: a first range designator which designates a first range as a distance change range of the second changer when the contrast of the object falls below the reference; and a second range designator which designates a second range narrower than the first range as a distance change range of the second changer when the contrast of the object is equal to or more than the reference.

In a certain aspect, the first changer executes a changing process in the first range.

In other aspect, further comprised is a distance detector which provisionally detects the distance corresponding to the focal point based on the object scene image outputted from the imager, in parallel with the changing process of the first changer, wherein the second range is equivalent to a range including the distance detected by the distance detector.

Preferably, further comprised are: an extractor which extracts a high-frequency component exceeding a designated frequency from the object scene image outputted from the imager; a decreaser which decreases a magnitude of the designated frequency when the contrast of the object falls below the reference; and an increaser which increases the magnitude of the designated frequency when the contrast of the object is equal to or more than the reference.

Preferably, further comprised are: a brightness detector which detects brightness of a plurality of portions of the object scene based on the object scene image outputted from the imager; and a contrast detector which detects the contrast of the object based on a detection result of the detector.

A focusing control program product according to the present invention is a focusing control program product executed by a processor of an electronic camera provided with an imager which repeatedly outputs an object scene image produced on an imaging surface capturing an object scene through a focus lens, comprising: a first changing step of repeatedly changing by each first amount a distance from the focus lens to the imaging surface; a second changing step of repeatedly changing by each second amount, smaller than the first amount, the distance from the focus lens to the imaging surface; an adjusting step of adjusting the distance from the focus lens to the imaging surface to a distance corresponding to a focal point based on the object scene image outputted from the imager, in parallel with a changing process of the first changing step and/or the second changing step; and a restricting step of restricting the changing process of the first changing step when a contrast of an object belonging to the object scene falls below a reference.

A focusing control method according to the present invention is a focusing control method executed by an electronic camera provided with an imager which repeatedly outputs an object scene image produced on an imaging surface capturing an object scene through a focus lens, comprising: a first changing step of repeatedly changing by each first amount a distance from the focus lens to the imaging surface; a second changing step of repeatedly changing by each second amount, smaller than the first amount, the distance from the focus lens to the imaging surface; an adjusting step of adjusting the distance from the focus lens to the imaging surface to a distance corresponding to a focal point based on the object scene image outputted from the imager, in parallel with a changing process of the first changing step and/or the second changing step; and a restricting step of restricting the changing process of the first changing step when a contrast of an object belonging to the object scene falls below a reference.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a configuration of one embodiment of the present invention;

FIG. 2 is an illustrative view showing one example of an allocation state of an evaluation area in an imaging surface;

FIG. 3(A) is an illustrative view showing one example of a rough adjustment-use table;

FIG. 3(B) is an illustrative view showing one example of a fine adjustment-use table;

FIG. 4 is a graph showing one example of a rough adjusting operation corresponding to an object scene including an object of which the contrast is equal to or more than a reference;

FIG. 5 is a graph showing one example of a fine adjusting operation corresponding to an object scene including an object of which the contrast is equal to or more than the reference;

FIG. 6 is a graph showing one example of a fine adjusting operation corresponding to an object scene including an object of which the contrast falls below the reference;

FIG. 7 is a flowchart showing one portion of an operation of a CPU applied to the embodiment in FIG. 1;

FIG. 8 is a flowchart showing another portion of the operation of the CPU applied to the embodiment in FIG. 1;

FIG. 9 is a flowchart showing still another portion of the operation of the CPU applied to the embodiment in FIG. 1;

FIG. 10 is a flowchart showing yet still another portion of the operation of the CPU applied to the embodiment in FIG. 1; and

FIG. 11 is a flowchart showing another portion of the operation of the CPU applied to the embodiment in FIG. 1.

### DETAILED DESCRIPTION OF THE PREFERRED EMBODIMENTS

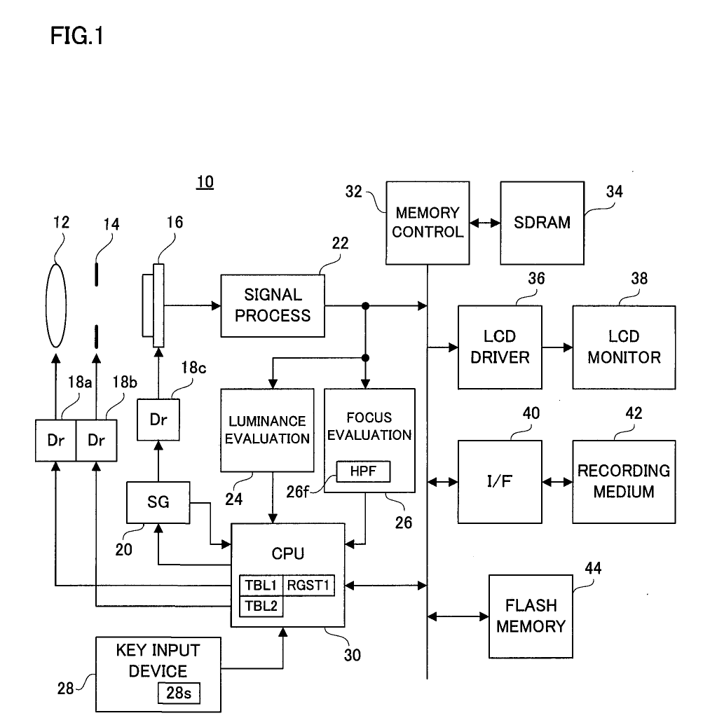

With reference to FIG. 1, a digital camera 10 according to this embodiment includes a focus lens 12 and an aperture mechanism 14 respectively driven by drivers 18a and 18b. An optical image of an object scene that undergoes the focus lens 12 and the aperture mechanism 14 is irradiated onto an imaging surface of an imaging device 16, and subjected to photoelectric conversion. Thereby, electric charges representing an object scene image are produced.

When a power supply is turned on, a CPU 30 commands a driver 18c to repeatedly perform a pre-exposure operation and a thinning-out reading-out operation in order to execute a through-image process. In response to a vertical synchronization signal Vsync cyclically generated from an SG (Signal Generator) 20, the driver 18c performs the pre-exposure on the imaging surface and also reads out the electric charges produced on the imaging surface in a thinning-out manner. From the imaging device 16, low-resolution raw image data based on the read-out electric charges is cyclically outputted in a raster scanning manner.

A signal-processing circuit 22 performs processes, such as white balance adjustment, color separation, and YUV conversion, on the raw image data outputted from the imaging device 16, and writes image data of a YUV format created thereby into an SDRAM 34 through a memory control circuit 32. An LCD driver 36 repeatedly reads out the image data written into the SDRAM 34 through the memory control circuit 32, and drives an LCD monitor 38 based on the read-out image data. As a result, a real-time moving image (through image) of the object scene is displayed on a monitor screen.

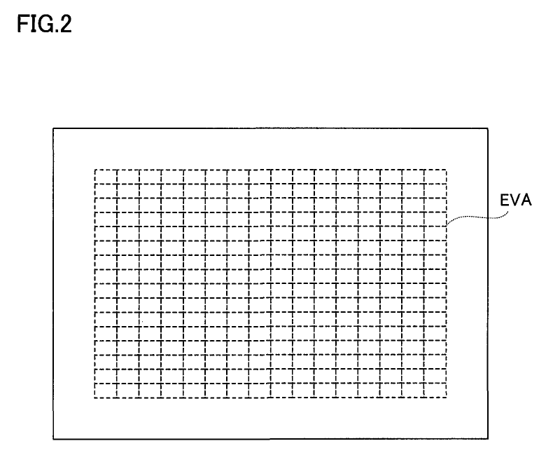

With reference to FIG. 2, an evaluation area EVA is allocated to a center of the imaging surface. The evaluation area EVA is divided into 16 parts in each of a vertical direction and a horizontal direction. That is, the evaluation area EVA is equivalent to a group of a total of 256 divided areas.

In response to the vertical synchronization signal Vsync, a luminance evaluating circuit 24 integrates Y data belonging to the evaluation area EVA, out of Y data outputted from a signal processing circuit 22, for each divided area. As a result, 256 AE evaluation values respectively corresponding to the 256 divided areas are outputted from the AE evaluating circuit 24 in response to the vertical synchronization signal Vsync. The CPU 30 repeatedly executes a through image-use AE process (simple AE process) in parallel with the above-described through-image process, in order to calculate an appropriate EV value based on the 256 luminance evaluation values outputted from the AE evaluating circuit 24. An aperture amount and an exposure time period that define the calculated appropriate EV value are set to the drivers 18b and 18c, respectively. As a result, the brightness of the through image displayed on the LCD monitor 38 is moderately adjusted.

When a shutter button 28s on a key input device 28 is half-depressed, a strict recording-use AE process is executed in order to calculate an optimal EV value based on the 256 luminance evaluation values outputted from the luminance evaluating circuit 24. Similarly to the above-described case, an aperture amount and an exposure time period that define the calculated optimal EV value are set to the drivers 18b and 18c, respectively.

Upon completion of the recording-use AE process, an AF process based on output of a focus evaluating circuit 26 is executed. The focus evaluating circuit 26 extracts a high-frequency component (high-frequency component: a frequency component that exceeds a cut-off frequency) of the Y data belonging to the evaluation area EVA, out of the Y data outputted from the signal processing circuit 22, by utilizing an HPF 26f, and in response to the vertical synchronization signal Vsync, integrates the extracted high-frequency component for each divided area. Thereby, the 256 AF evaluation values respectively corresponding to the 256 divided areas are outputted from the focus evaluating circuit 26 in response to the vertical synchronization signal Vsync.

The CPU 30 fetches the AF evaluation values thus outputted from the focus evaluating circuit 26, and seeks a position corresponding to a focal point by a so-called hill-climbing process. The focus lens 12 moves stepwise in an optical axis direction at each generation of the vertical synchronization signal Vsync, and thereafter, is placed at the position corresponding to the focal point.

When the shutter button 28s is fully depressed, a recording process is executed. The CPU 30 commands the driver 18c to execute a main exposure operation and all-pixel reading-out, one time each. The driver 18c performs the main exposure on the imaging surface in response to the generation of the vertical synchronization signal Vsync, and reads out all the electric charges produced in an electric-charge reading-out area in a raster scanning manner. As a result, high-resolution raw image data representing the object scene is outputted from the imaging device 16.

Outputted raw image data is subjected to a process similar to that described above, and as a result, high-resolution image data according to a YUV format is secured in the SDRAM 34. An PF 40 reads out the high-resolution image data thus accommodated in the SDRAM 34 through the memory control circuit 32, and then, records the read-out image data on a recording medium 42 in a file format It is noted that the through-image process is resumed at a time point when the high-resolution image data is accommodated in the SDRAM 34.

The AF process is executed as described below. Firstly, out of the 256 luminance evaluation values noticed at a time of the recording-use AE process, a maximum luminance evaluation value and a minimum luminance evaluation value are specified, and a difference between the specified maximum luminance evaluation value and minimum luminance evaluation value is calculated. The calculated difference is compared with a threshold value TH. When the difference≧the threshold value TH is established, it is regarded that the contrast of an object existing in the object scene is equal to or more than a reference, and on the other hand, when the difference<the threshold value TH is established, it is regarded that the contrast of the object existing in the object scene is below the reference. It is noted that the “contrast of the object” may also be called a “high-frequency component of an object” or a “flatness of an object”.

When the contrast of the object is equal to or more than the reference, the cut-off frequency of the HPF 26f arranged in the focus evaluating circuit 26 is set to a high-band frequency FH, and in this state, a rough adjusting process that covers the whole area of a range that needs to be searched of the focus lens 12 as a rough adjustment range, a fine adjusting process that covers one portion of the range including a provisional peak position PPeak detected by the rough adjusting process as a fine adjustment range, and a position finalizing process for placing the focus lens 12 at a finalized peak position FPeak detected by the fine adjusting process are executed.

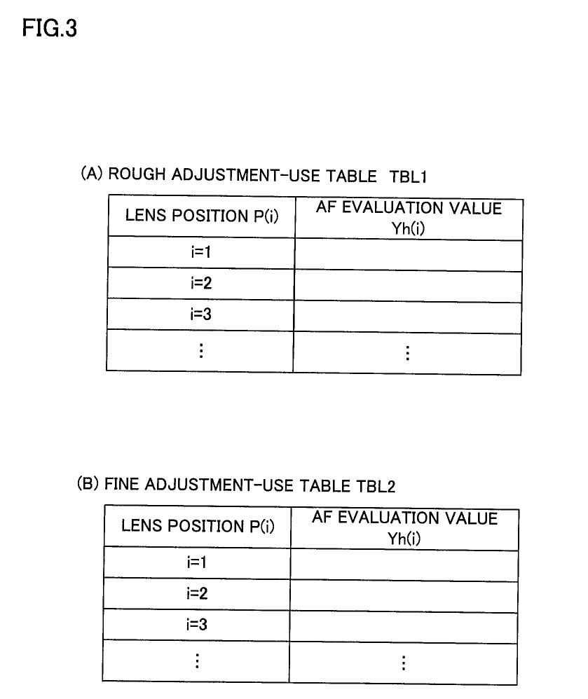

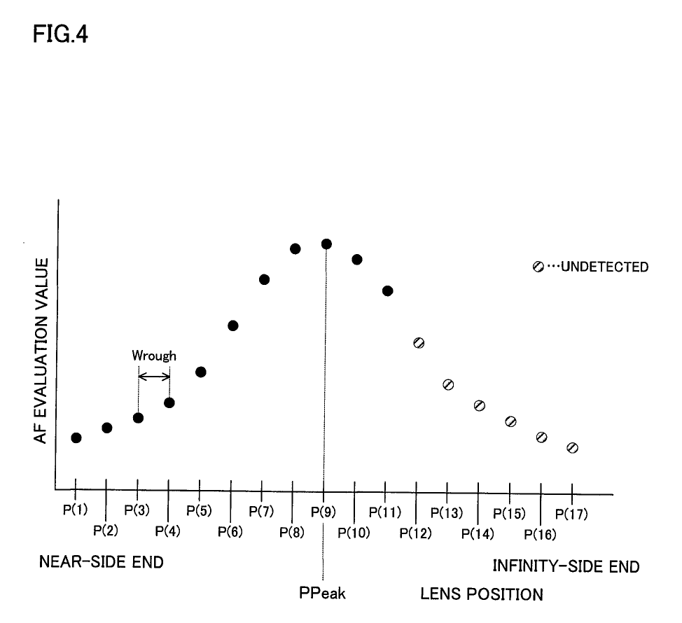

Upon performing the rough adjusting process, the focus lens 12 is placed at a near-side end in a rough adjustment range shown in FIG. 4, and is moved toward an infinity-side end by a moving amount Wrough. The focus evaluating circuit 26 outputs a high-frequency component of an object scene image captured at each of a plurality of lens positions P(i) (i: 1, 2, 3, . . . ) separated by a distance equivalent to the moving amount Wrough, as an AF evaluation value Yh(i). On a rough adjustment-use table TBL1 shown in FIG. 3(A), the AF evaluation values Yh(i) thus obtained are written.

The AF evaluation value fetched this time from the focus evaluating circuit 26 is registered in a register RGST 1 as a maximum AF evaluation value when the same value is equal to or more than the AF evaluation values fetched until last time. When the AF evaluation values fetched after this fall below the maximum AF evaluation value for consecutive two times, it is regarded that the focus lens 12 spans the focal point As a result, a lens position corresponding to the maximum AF evaluation value, out of the plurality of AF evaluation values written on the rough adjustment-use table TBL1, is detected as the provisional peak position PPeak. The rough adjusting process is ended as a result of the provisional peak position PPeak being detected.

According to FIG. 4, the AF evaluation value is maximum corresponding to a lens position P(9), and the lens position P(9) is set as the provisional peak position PPeak. The rough adjusting process is ended without acquiring the AF evaluation values Yh(12) to Yh(17) of the lens positions P(12) to P(17).

Upon ending the rough adjusting process, one portion of the range where the provisional peak position PPeak is centered is defined as the fine adjustment range. The extent of the fine adjustment range is equivalent to five times that of the moving amount Wfine that is smaller than the moving amount Wrough.

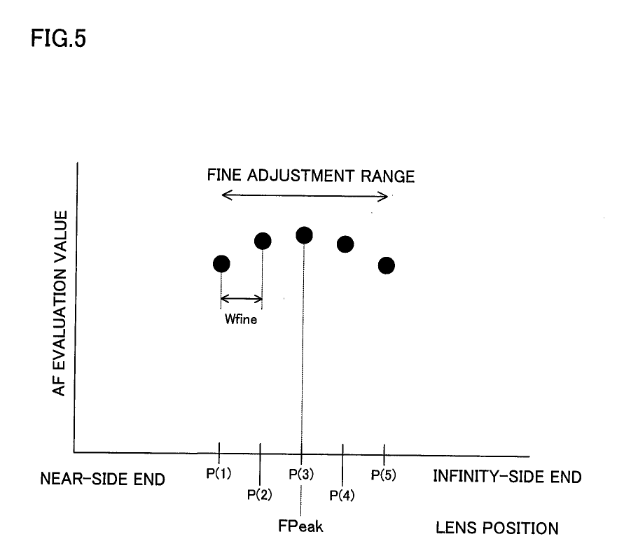

At a time of the fine adjusting process, the focus lens 12 is placed at a near-side end of a fine adjustment range shown in FIG. 5, and is moved toward an infinity-side end by the moving amount Wfine. Similarly to the above-described case, the focus evaluating circuit 26 outputs the high-frequency component of an object scene image captured at each of a plurality of lens positions P(i) (i: 1, 2, 3, . . . ) separated by a distance equivalent to the moving amount Wfine, as an AF evaluation value Yh(i). On a fine adjustment-use table TBL2 shown in FIG. 3(B), the AF evaluation values Yh(i) thus obtained are written. The fine adjusting process is ended at a time point when the AF evaluation value Yh(i) corresponding to the infinity-side end of the fine adjustment range is acquired.

In the position finalizing process that follows the fine adjusting process, the maximum AF evaluation value is specified from the fine adjustment-use table TBL2, and a lens position corresponding to the specified maximum AF evaluation value is detected as the finalized peak position FPeak (position corresponding to the focal point). The focus lens 12 is placed at the finalized peak position Fpeak.

According to FIG. 5, the AF evaluation value is maximum corresponding to a lens position P(3), and the lens position P(3) is set as the finalized peak position FPeak. The focus lens 12 is placed at the lens position P(3).

On the other hand, when the contrast of the object falls below the reference, the cut-off frequency of the HPF 26f arranged in the focus evaluating circuit 26 is set to a low-band frequency FL, and in this state, the fine adjusting process that covers the whole area of a range that needs to be searched of the focus lens 12 as the fine adjustment range, and the position finalizing process for placing the focus lens 12 at the finalized peak position FPeak detected by the fine adjusting process are executed. Unlike a case where the contrast of the object is equal to or more than the reference, the rough adjusting process is restricted or prohibited.

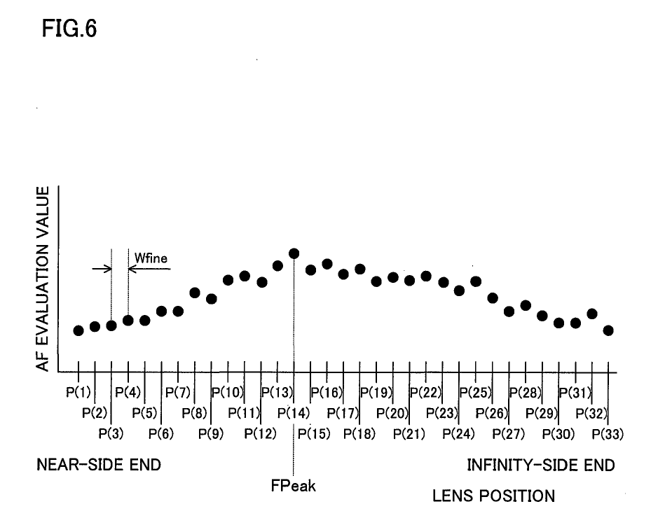

With reference to FIG. 6, the focus lens 12 is placed at the near-side end of the fine adjustment range, and is moved toward the infinity-side end by the moving amount Wfine. On the fine adjustment-use table TBL2, similarly to the above-described case, the AF evaluation value Yh(i) corresponding to each of a plurality of lens positions P(i) (i: 1, 2, 3, . . . ) separated by the distance equivalent to the moving amount Wfine is written. The fine adjusting process is ended at a time point when the AF evaluation value Yh(i) corresponding to the infinity-side end of the fine adjustment range is acquired.

In the position finalizing process, similarly to the above-described case, the maximum AF evaluation value is specified from the fine adjustment-use table TBL2, and a lens position corresponding to the specified maximum AF evaluation value is detected as the finalized peak position FPeak. The focus lens 12 is placed at the finalized peak position Fpeak.

According to FIG. 6, the AF evaluation value is maximum corresponding to a lens position P(14), and the lens position P(14) is set as the finalized peak position FPeak. The focus lens 12 is placed at the lens position P(14).

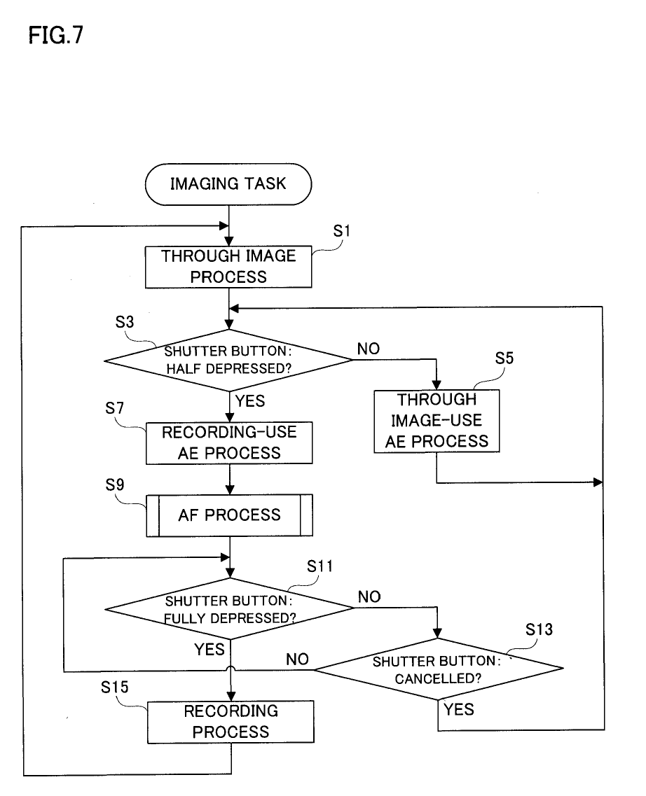

The CPU 30 executes a process according to an imaging task shown in FIG. 7 to FIG. 11. A control program corresponding to the imaging task is stored in a flash memory 44.

Firstly in a step S1, the through-image process is executed. As a result, the through image that represents the object scene is outputted from the LCD monitor 38. In a step S3, it is determined whether or not the shutter button 28s is half-depressed, and as long as the determination result indicates NO, the through image-use AE process in a step S5 is repeated. As a result, the brightness of the through image is adjusted moderately. When the shutter button 28s is half-depressed, the recording-use AE process is executed in a step S3, and the AF process is executed in a step S7. By the process in the step S7, the brightness of the through image is adjusted to an optimum value, and by the process in the step S9, the focus lens 12 is placed at the focal point.

In a step S11, it is determined whether or not the shutter button 28s is fully depressed, and in a step S13, it is determined whether or not the manipulation of the shutter button 28s is cancelled. When YES is determined in the step S11, the process returns to the step Si after undergoing a recording process in a step S15. When YES is determined in the step S13, the process returns to the step S3 as it is.

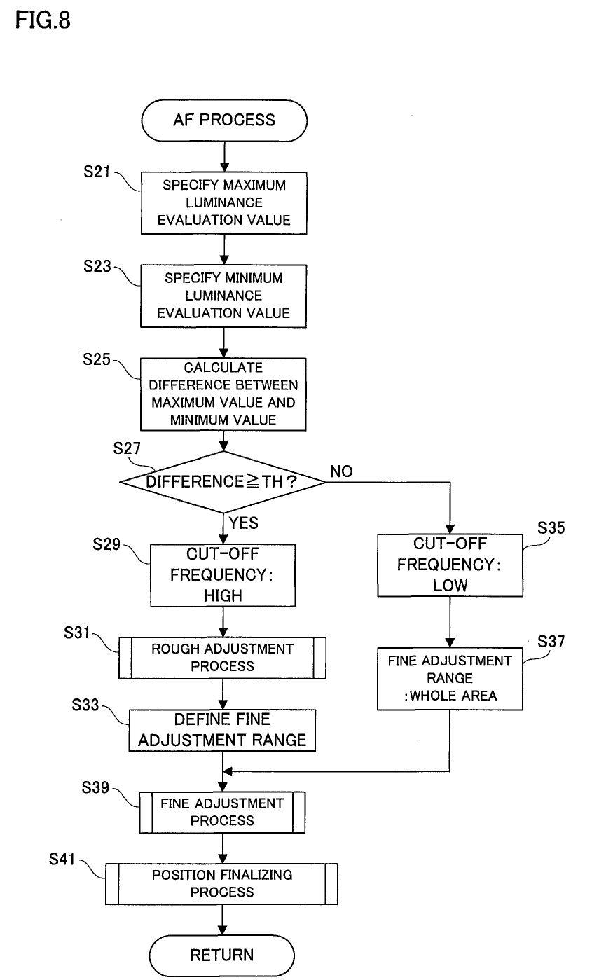

The AF process in the step S9 is executed according to a sub-routine shown in FIG. 8 to FIG. 11. In a step S21, out of the 256 luminance evaluation values fetched for the recording-use AE process in the step S7, the maximum luminance evaluation value is specified. In a step S23, out of the same 256 luminance evaluation values, the minimum luminance evaluation value is specified. In a step S25, the difference between the specified maximum luminance evaluation value and minimum luminance evaluation value is calculated, and in a step S27, it is determined whether or not the calculated difference is equal to or more than the threshold value TH. When the determination result is YES, the process advances to a step S29 regarding that the contrast of the object belonging to the object scene is equal to or more than the reference. On the other hand, when the determination result is NO, the process advances to a step S35 regarding that the contrast of the object belonging to the object scene falls below the reference.

In the step S29, the cut-off frequency of the HPF 26f is set to the high-band frequency FH, and in a subsequent step S31, the rough adjusting process is executed. In a step S33, by using the provisional peak position PPeak detected by the rough adjusting process as the center, a range having space equivalent to “Wfine×5” is defined as the fine adjustment range. On the other hand, in the step S35, the cut-off frequency of the HPF 26f is set to the low-band frequency FL, and in a subsequent step S37, the whole area of the range that needs to be searched of the focus lens 12 is defined as the fine adjustment range. Upon completion of the process in the step S33 or S37, the fine adjusting process is executed in a step S39, and in a step S41, the position finalizing process is further executed. Upon completion of the process in the step S41, the process is restored to a routine at a hierarchical upper level.

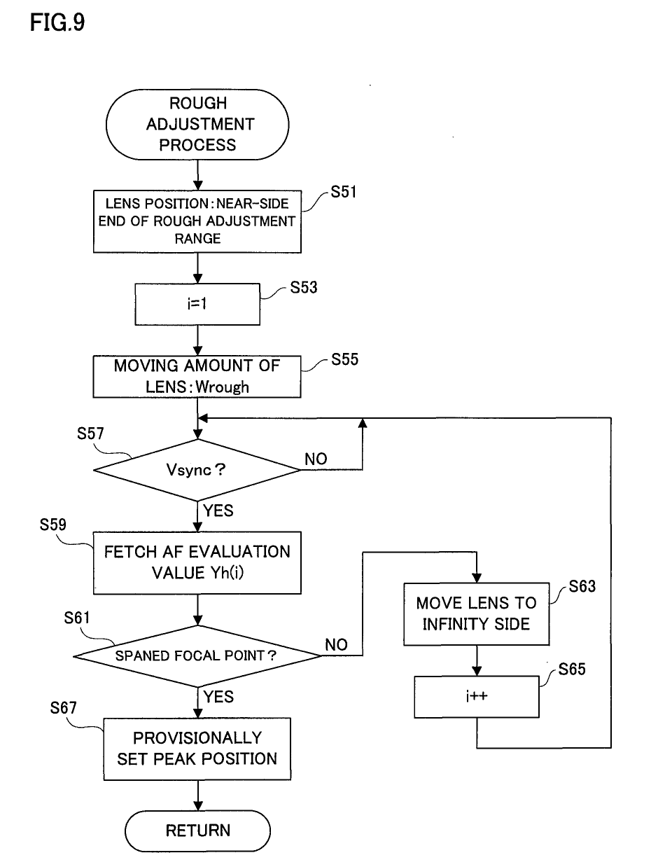

The rough adjusting process in the step S31 is executed according to a subroutine shown in FIG. 9. Firstly, in a step S51, the focus lens 12 is placed at the near-side end of the rough adjustment range. In a step S53, a variable i is set to “1”, and in a step S55, the moving amount of the focus lens 12 is set to “Wrough”.

When the vertical synchronization signal Vsync is generated, the process advances from a step S57 to a step S59 in which to fetch the AF evaluation value Yh(i) from the focus evaluating circuit 26. The fetched AF evaluation value Yh(i) is associated with the lens position P(i), and the resultant value is written on the rough adjustment-use table TBL1 shown in FIG. 3(A).

In a step S61, it is determined whether or not the focus lens 12 has spanned the focal point based on a plurality of AF evaluation values written on the rough adjustment-use table TBL1. If NO is determined in this step, the focus lens 12 is moved by the moving amount Wrough to the infinity side in a step S63, and the variable i is incremented in a step S65. Then, the process returns to the step S57. When the determination result in the step S61 is YES, the process advances to a step S67 so as to set the lens position corresponding to the maximum AF evaluation value, out of the plurality of AF evaluation values written on the rough adjustment-use table TBL1, as the provisional peak position PPeak. Upon completion of the process in the step S67, the process is restored to a routine at a hierarchical upper level.

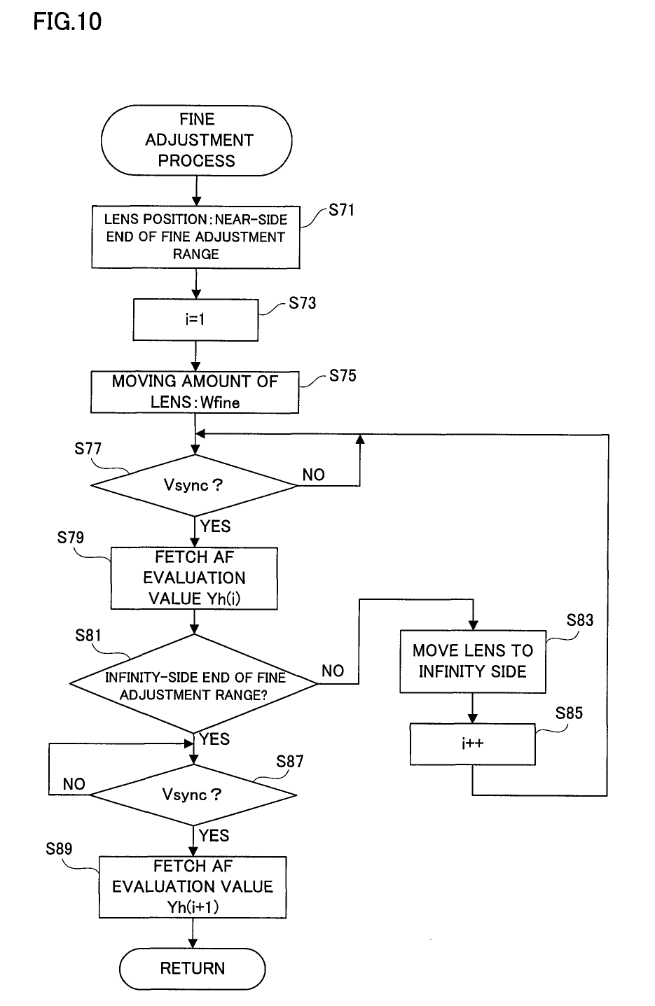

The fine adjusting process in the step S39 shown in FIG. 8 is executed according to a subroutine shown in FIG. 10. Firstly, in a step S71, the focus lens 12 is placed at the near-side end of the fine adjustment range. In a step S73, the variable i is set to “1”, and in a step S75, the moving amount of the focus lens 12 is set to “Wfine”. When the vertical synchronization signal Vsync is generated, the process advances from a step S77 to a step S79 in which to fetch the AF evaluation value Yh(i) from the focus evaluating circuit 26. The fetched AF evaluation value Yh(i) is associated with the lens position P(i), and the resultant value is written on the fine adjustment-use table TBL2 shown in FIG. 3(B).

In a step S81, it is determined whether or not the focus lens 12 reaches the infinity-side end of the fine adjustment range. If NO is determined in this step, the focus lens 12 is moved by the moving amount Wfine to the infinity side in a step S83. Upon completion of the moving process, the variable i is incremented in a step S85, and then, the process returns to the step S77.

When YES is determined in the step S81, the process waits for the generation of the vertical synchronization signal Vsync, and then, advances from a step S87 to a step S89 in which to fetch the AF evaluation value Yh(i+1) from the focus evaluating circuit 26. The fetched AF evaluation value Yh(i+1) is associated with the lens position P(i+1), and the resultant value is written on the fine adjustment-use table TBL2. Upon completion of the process in the step S89, the process is restored to a routine at a hierarchical upper level.

It is noted that the processes from the steps S87 to S89 are processes in consideration of a fact that the output operation of the raw image data from the imaging device 16 is delayed by 1-frame period from the exposing operation of the imaging surface.

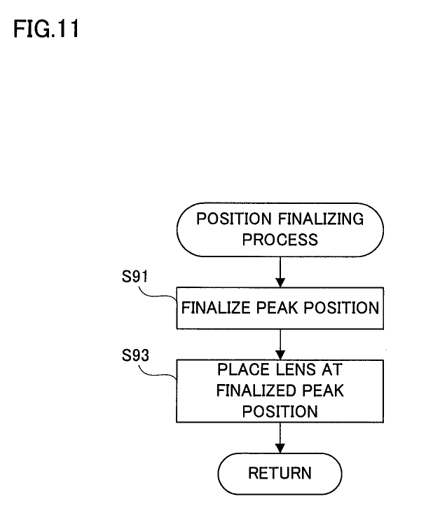

The process in the step S41 shown in FIG. 8 is executed according to a subroutine shown in FIG. 11. In a step S91, the maximum AF evaluation value is specified out of the plurality of AF evaluation values written on the fine adjustment-use table TBL2, and the lens position corresponding to the specified maximum AF evaluation value is detected as the finalized peak position FPeak. In a step S93, the focus lens 12 is placed at the detected finalized peak position FPeak, i.e., a position corresponding to the focal point. Upon completion of the process in the step S93, the process is restored to a routine at a hierarchical upper level.

As understood from the above-described description, the imaging device 16 repeatedly outputs the object scene image produced on the imaging surface capturing the object scene through the focus lens 12. The position of the focus lens 12 is repeatedly changed by the moving amount Wrough under the control of the CPU 30 (S51, S55, and S63). The distance from the focus lens 12 to the imaging surface is repeatedly changed by the moving amount Wfine, smaller than the moving amount Wrough, under the control of the CPU 30 (S71, S75, and S83). The CPU 30 adjusts the position of the focus lens 12 to the position corresponding to the focal point, based on the object scene image outputted from the imaging device 16 in parallel with such a rough adjusting process and/or fine adjusting process (S59, S79, S89, and S91 to S93). However, the CPU 30 restricts the rough adjusting process when the contrast of the object belonging to the object scene falls below a reference (S27).

Therefore, when the contrast of the object belonging to the object scene is high, the focal point is sought based on both the object scene image produced in parallel with the rough adjusting process and the object scene image produced in parallel with the fine adjusting process. Thereby, it becomes possible to improve the focal accuracy for the object scene of the high contrast.

In contrary, when the contrast of the object belonging to the object scene is low, the rough adjusting process is restricted, and the focal point is sought based on the object scene image produced in parallel with the fine adjusting process. Thereby, it becomes possible to inhibit the decrease in focal accuracy for the object of the low contrast.

It is noted that in this embodiment, the focus lens 12 is moved in an optical axis direction at a time of the AF process. However, instead of the focus lens 12 or together with the focus lens 12, the imaging surface may be optionally moved in an optical axis direction.

Also, in this embodiment, during the rough adjusting process, the lens moving operation is ended at a time point when the focus lens 12 spans the focal point (see the step S61 in FIG. 9). However, the rough adjusting process may be optionally ended after the focus lens 12 reaches the infinity-side end of the rough adjustment range.

Moreover, in this embodiment, in both the rough adjusting process and the fine adjusting process, the focus lens 12 is moved from a vicinity of the near-side end to the infinity side (see the steps S51 and S63 in FIG. 9, and the steps S71 and S83 in FIG. 10). However, in the fine adjusting process executed after the rough adjusting process, the focus lens 12 may be optionally moved from the infinity-side end to the near-side. Also, during the rough adjusting process, the focus lens 12 may be optionally moved from the infinity-side end to the near-side end.

Moreover, in this embodiment, during the fine adjusting process, the lens moving operation is continued until the focus lens 12 reaches the infinity-side end of the fine adjustment range (see the step S81 in FIG. 10). However, in the fine adjusting process executed after the rough adjusting process, the lens moving operation may be optionally ended at a time point when the focus lens 12 spans the focal point.

Furthermore, in this embodiment, the lens position corresponding to the maximum AF evaluation value written on the fine adjustment-use table TBL2 is detected as the finalized peak position FPeak. However, the finalized peak position FPeak may also be detected as follows: the plurality of AF evaluation values written on the fine adjustment-use table TBL2 are plotted along an approximate curve, and the lens position corresponding to a peak of the resultant approximate curve is detected as the finalized peak position FPeak.

Also, in this embodiment, in order to determine the level of the contrast of the object belonging to the object scene, the difference between the maximum luminance evaluation value and the minimum luminance evaluation value is utilized. However, in addition thereto, any index may be optionally utilized as long as it is possible to use as a rough indication to determine the level of the contrast.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager which repeatedly outputs an object scene image produced on an imaging surface capturing an object scene through a focus lens;
a first changer which repeatedly changes by each first amount a distance from said focus lens to said imaging surface;
a second changer which repeatedly changes by each second amount, smaller than said first amount, the distance from said focus lens to said imaging surface;
an adjuster which adjusts the distance from said focus lens to said imaging surface to a distance corresponding to a focal point based on the object scene image outputted from said imager, in parallel with a changing process of said first changer and/or said second changer; and
a restrictor which restricts the changing process of said first changer when a contrast of an object belonging to said object scene falls below a reference.

2. An electronic camera according to claim 1, further comprising:
a first range designator which designates a first range as a distance change range of said second changer when the contrast of said object falls below the reference; and
a second range designator which designates a second range narrower than said first range as a distance change range of said second changer when the contrast of said object is equal to or more than the reference.

3. An electronic camera according to claim 2, wherein said first changer executes a changing process in said first range.

4. An electronic camera according to claim 2, further comprising a distance detector which provisionally detects the distance corresponding to said focal point based on the object scene image outputted from said imager, in parallel with the changing process of said first changer, wherein said second range is equivalent to a range including the distance detected by said distance detector.

5. An electronic camera according to claim 1, further comprising:
an extractor which extracts a high-frequency component exceeding a designated frequency from the object scene image outputted from said imager;
a decreaser which decreases a magnitude of said designated frequency when the contrast of said object falls below said reference; and
an increaser which increases the magnitude of said designated frequency when the contrast of said object is equal to or more than said reference.

6. An electronic camera according to claim 1, further comprising:
a brightness detector which detects brightness of a plurality of portions of said object scene based on the object scene image outputted from said imager; and
a contrast detector which detects the contrast of said object based on a detection result of said detector.

7. A focusing control program product executed by a processor of an electronic camera provided with an imager which repeatedly outputs an object scene image produced on an imaging surface capturing an object scene through a focus lens, comprising:
a first changing step of repeatedly changing by each first amount a distance from said focus lens to said imaging surface;
a second changing step of repeatedly changing by each second amount, smaller than said first amount, the distance from said focus lens to said imaging surface;
an adjusting step of adjusting the distance from said focus lens to said imaging surface to a distance corresponding to a focal point based on the object scene image outputted from said imager, in parallel with a changing process of said first changing step and/or said second changing step; and
a restricting step of restricting the changing process of said first changing step when a contrast of an object belonging to said object scene falls below a reference.

8. A focusing control method executed by an electronic camera provided with an imager which repeatedly outputs an object scene image produced on an imaging surface capturing an object scene through a focus lens, comprising:
a first changing step of repeatedly changing by each first amount a distance from said focus lens to said imaging surface;
a second changing step of repeatedly changing by each second amount, smaller than said first amount, the distance from said focus lens to said imaging surface;
an adjusting step of adjusting the distance from said focus lens to said imaging surface to a distance corresponding to a focal point based on the object scene image outputted from said imager, in parallel with a changing process of said first changing step and/or said second changing step; and
a restricting step of restricting the changing process of said first changing step when a contrast of an object belonging to said object scene falls below a reference.
